(19) United States
(12) Patent Application Publication
(10) Pub. No.: US 2025/0274831 A1
(43) Pub. Date: Aug. 28, 2025

(54) SEAMLESS ROAMING FRAMEWORK

(71) Applicant: Cisco Technology, Inc., San Jose, CA (US)

(72) Inventors: Binita GUPTA, San Diego, CA (US); Brian D. HART, Sunnyvale, CA (US); Stephen M. ORR, Wallkill, NY (US); Sudhir K. JAIN, Fremont, CA (US)

(21) Appl. No.: 19/057,724

(22) Filed: Feb. 19, 2025

Related U.S. Application Data
(60) Provisional application No. 63/559,065, filed on Feb. 28, 2024.

(51) Int. Cl. H04W 36/18; H04W 12/041; H04W 12/106; H04W 36/00

(52) U.S. Cl. CPC H04W 36/18; H04W 12/041; H04W 12/106; H04W 36/0033

(57) ABSTRACT

The present disclosure describes a hierarchical seamless roaming technique. A wireless network includes a first access point device and a second access point device. The first access point device and the second access point device are assigned to a first seamless mobility domain (SMD) and a fast basic service set transition mobility domain (FT MD). The first access point device receives, from a client device, an association request that identifies the FT MD and the first SMD and establishes a first pairwise master key R1 (PMK-R1). The first access point device also generates a first pairwise transient key for the client device, and the second access point device establishes, based on the association request identifying the first SMD and the FT MD and based on the second access point device being assigned to the first SMD and the FT MD, a second PMK-R1.

### CROSS-REFERENCE TO RELATED APPLICATIONS

This application claims benefit of co-pending U.S. provisional patent application Ser. No. 63/559,065 filed Feb. 28, 2024. The aforementioned related patent application is herein incorporated by reference in its entirety.

### TECHNICAL FIELD

Embodiments presented in this disclosure generally relate to wireless communication. More specifically, embodiments disclosed herein a hierarchical seamless roaming technique.

### BACKGROUND

Seamless roaming is used in wireless networks (e.g., wireless fidelity (Wi-Fi) networks) to reduce transition times and delays when roaming between access points. Many network deployments today, however, use a technique called Fast BSS Transition (FT) to roam between access points. FT typically requires the client device to perform FT authentication and to re-associate with the target access point, and FT typically does not preserve the context of the client device during roaming, which breaks data continuity. As a result, FT is not entirely seamless and introduces delays.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network management entity, access point, or device in the system of FIG. 1A.

FIG. 2A illustrates an example operation performed by the system of FIG. 1A.

FIG. 2B illustrates an example message used in the system of FIG. 1A.

FIG. 2C illustrates an example message used in the system of FIG. 1A.

FIG. 3 illustrates an example operation performed by the system of FIG. 1A.

FIG. 4A illustrates an example operation performed by the system of FIG. 1A.

FIG. 4B illustrates an example operation performed by the system of FIG. 1A.

FIGS. 5A and 5B illustrate example operations performed by the system of FIG. 1A.

FIG. 6 is a flowchart of an example method performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a hierarchical seamless roaming technique. According to an embodiment, a wireless network includes a first access point device and a second access point device. The first access point device is assigned to a first seamless mobility domain (SMD) and a fast basic service set transition mobility domain (FT MD). The second access point device is assigned to the first SMD and the FT MD. The first access point device receives, from a client device, a request that includes (i) a first element identifying the FT MD and (ii) a second element identifying the first SMD and establishes, based on the request, a first pairwise master key R1 (PMK-R1) for the first access point device. The first access point device also generates, based on the association request and the first PMK-R1, a first pairwise transient key (PTK) for the client device, and the second access point device establishes, based on the request received by the first access point device identifying the first SMD and the FT MD and based on the second access point being assigned to the first SMD and the FT MD, a second PMK-R1 for the second access point device.

According to another embodiment, a method includes receiving, from a client device and by a first access point device assigned to a first SMD and a FT MD, a request comprising (i) a first field identifying the FT MD and (ii) a second field identifying the first SMD and establishing, by the first access point device and based on the request, a first PMK-R1 for the first access point device. The method also includes generating, by the first access point device and based on the first PMK-R1, a first PTK for the client device and receiving, by a second access point device and based on (i) the request received by the first access point device identifying the first SMD and the FT MD and (ii) the second access point device being assigned to the first SMD and the FT MD, a second PMK-R1 for the second access point device.

According to another embodiment, a non-transitory computer readable medium stores instructions that, when executed by one or more processors, cause the one or more processors, individually or collectively, to perform an operation. The operation includes establishing, based on a request received by a first access point device assigned to a SMD and a FT MD, a first PMK-R1 for the first access point device and establishing, based on the association request received by the first access point device identifying the SMD and the FT MD and based on a second access point device being assigned to the SMD and the FT MD, a second PMK-R1 for the second access point device.

### EXAMPLE EMBODIMENTS

The present disclosure describes a wireless network (e.g., a wireless fidelity (Wi-Fi) network) that implements a hierarchical seamless roaming technique to achieve seamless roaming using a Fast BSS Transition (FT) framework. Generally, the access points in the network are assigned to groups called seamless mobility domains (SMDs). Multiple SMDs are assigned to groups called fast basic service set transition mobility domains (FT MDs). An access point in an SMD may communicate information to other access points in the SMD such that the other access points establish pairwise transient keys (PTKs) for communicating with a client device that is associated with the access point. In this manner, the access points in the SMD are prepared to communicate with the client device before the client device roams to those access points.

In certain embodiments, the network provides several technical advantages. For example, the network may reduce delays and transition times when roaming using the FT framework. As another example, the network may preserve client device context when roaming using the FT framework.

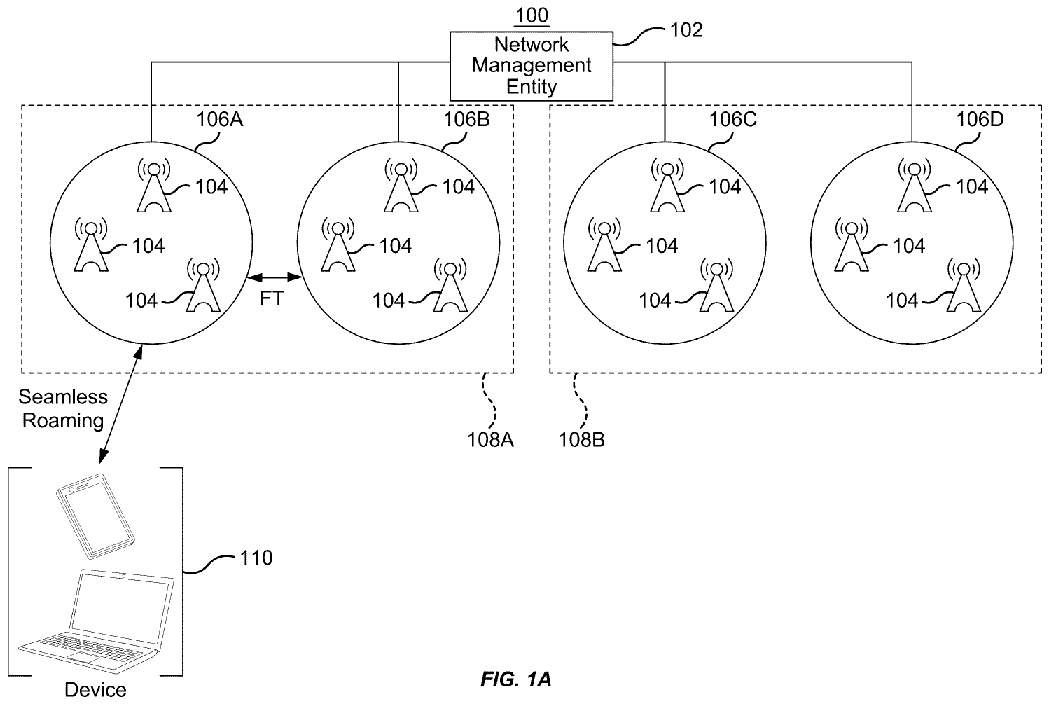

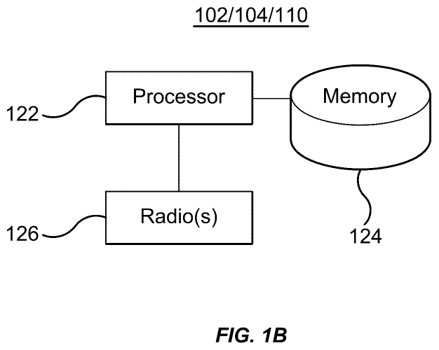

FIG. 1A illustrates an example system 100, which may be a wireless network (e.g., a Wi-Fi network). As seen in FIG. 1A, the system 100 includes multiple network devices including a network management entity 102 and multiple access points (which may be referred to as access point multi-link devices (AP MLDs) or access point devices) 104. The network management entity 102 may be hosted on a centralized network management entity or in a distributed fashion on individual access points 104. Generally, the system 100 groups the access points 104 such that the access points 104 in a group may establish different PTKs for communicating with a client device based on the FT key hierarchy and the FT framework. In this manner, the system 100 allows some of the access points 104 to perform seamless roaming using the FT framework, which may reduce transition times and delay when roaming, in certain embodiments.

The network management entity 102 facilitates or manages the communication in the system 100. For example, the network management entity 102 may group access points 104 into SMDs and/or FT MDs. As another example, the network management entity 102 may manage keys that the access points 104 use to communicate with each other and with client devices. The network management entity 102 may control or hold a pairwise master key R0 (PMK-R0) for communications with a client device. The network management entity 102 may use the PMK-R0 to generate a pairwise master key R1 (PMK-R1) for an access point 104. The network management entity 102 then communicates the PMK-R1 to the access point 104 and/or installs or establishes the PMK-R1 on the access point 104. The access point 104 may then use the PMK-R1 to generate a PTK that the access point 104 uses to encrypt and/or decrypt communications with the client device.

The access point 104 may be a network device that facilitates wireless communication (e.g., Wi-Fi communication) in the system 100. The network management entity 102 assigns multiple access points 104 into SMDs 106, and the network management entity 102 assigns multiple SMDs 106 into FT MDs 108. In the example of FIG. 1A, different access points 104 are assigned to the SMDs 106A, 106B, 106C, and 106D. The SMDs 106A and 106B are assigned to the FT MD 108A, and the SMDs 106C and 106D are assigned to the FT MD 108B. The access points 104 may be grouped into SMDs 106 and FT MDs 108 using any suitable criteria (e.g., the locations of the access points 104). For example, if the access points 104 were distributed throughout different floors of a building, access point 104 on the same floor of the building may be grouped into an SMD 106. SMDs 106 that correspond to floors within a range of floors of the building may be assigned to the same FT MD 108. In this manner, the SMDs 106 and the FT MDs 108 establish a hierarchy of groups of access points 104. These groups may then be used to implement seamless roaming using the FT framework.

One or more devices 110 (which may also be referred to as client devices) may connect to an access point 104. The access point 104 may then facilitate wireless communication for the devices 110. For example, a device 110 may communicate a message to the access point 104. The access point 104 may route the message towards its destination.

The device 110 may be any suitable device that wirelessly connects to an access point 104. As an example and not by way of limitation, the device 110 may be a computer, a laptop, a wireless or cellular telephone, an electronic notebook, a personal digital assistant, a tablet, or any other device capable of receiving, processing, storing, or communicating information with other components of the system 100. The device 110 may be a wearable device such as a virtual reality or augmented reality headset, a smart watch, or smart glasses. The device 110 may also include a user interface, such as a display, a microphone, keypad, or other appropriate terminal equipment usable by the user. The device 110 may include a hardware processor, memory, or circuitry configured to perform any of the functions or actions of the device 110 described herein. For example, a software application designed using software code may be stored in the memory and executed by the processor to perform the functions of the device 110.

The device 110 may typically connect to a first access point 104 that is closest to the device 110. The first access point 104 may be assigned to an SMD 106 that includes other access points 104. After the device 110 connects to the first access point 104, the network management entity 102 may generate a PMK-R0 for the device 110. The network management entity 102 may then generate PMKs-R1 for the other access points 104 in the SMD 106. The network management entity 102 communicates the PMKs-R1 to the other access points 104 in the SMD 106.

When the first access point 104 with which the device 110 is associated detects that the device 110 should or will roam to another access point 104 in the SMD 106 (e.g., due to a drop in signal or communication strength with the device 110), the first access point 104 may signal some other access points 104 in the SMD 106 to prepare for the device 110 to potentially roam to the other access points 104. The other access points may then generate PTKs for communicating with the device 110 before the device 110 initiates roaming with any of the other access points 104. Additionally, the device 110 may generate PTKs for communicating with these other access points 104. In this manner, when the device 110 roams to a second access point 104 in the SMD 106, the second access point 104 and the device 110 have PTKs already prepared for communication. To complete the roam, the first access point 104 may communicate context information (e.g., a sequence number and packet number for the last data packet communicated between the device 110 and the first access point 104 and/or the next data packet communicated between the device 110 and the first access point 104). The second access point 104 may then use the context information and the PTK for the device 110 to resume communications with the device 110. In this manner, the system 100 uses the FT framework (e.g., PMK-R0, PMK-R1, PTK, etc.) to implement seamless roaming in which the device 110 is not necessarily required to perform FT authentication with the second access point 104 and in which context for the device 110 is preserved during roaming. As a result, the system 100 reduces transition time and delays during the roam, in certain embodiments.

FIG. 1B illustrates an example network management entity 102, access point 104, and/or device 110 in the system 100 of FIG. 1A. As seen in FIG. 1B, the network management entity 102, access point 104, and/or device 110 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the network management entity 102, access point 104, and/or device 110. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network management entity 102, access point 104, and/or device 110 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network management entity 102, access point 104, and/or device 110 may use one or more of the radios 126 for Wi-Fi communications. The network management entity 102, access point 104, and/or device 110 may use one or more of the radios 126 to transmit messages and one or more of the radios 126 to receive messages. The network management entity 102, access point 104, and/or device 110 may include any number of radios 126 to communicate using any number of communication technologies.

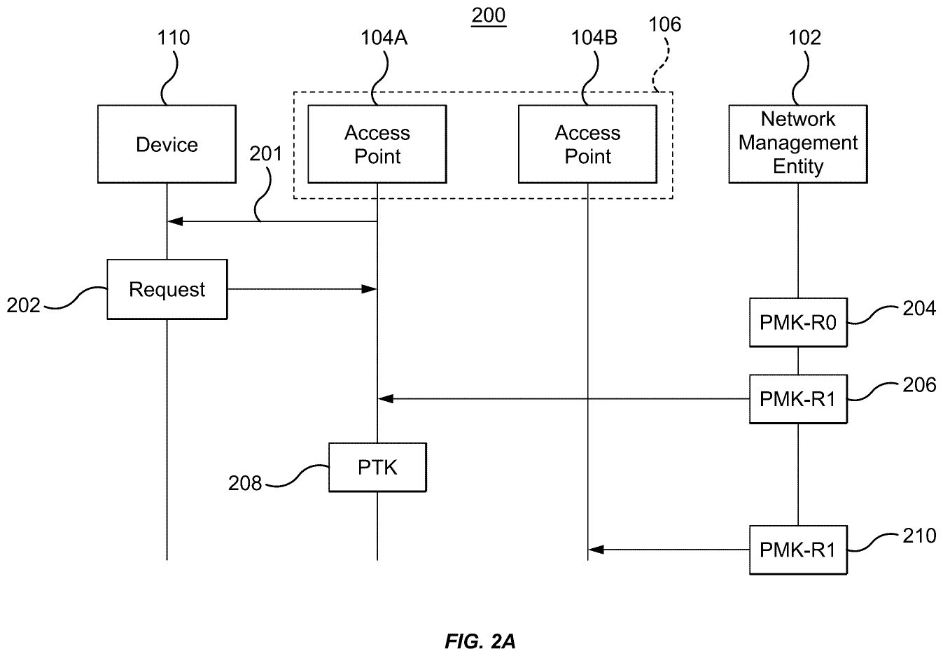

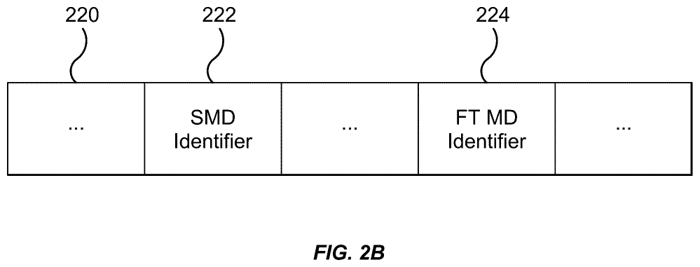

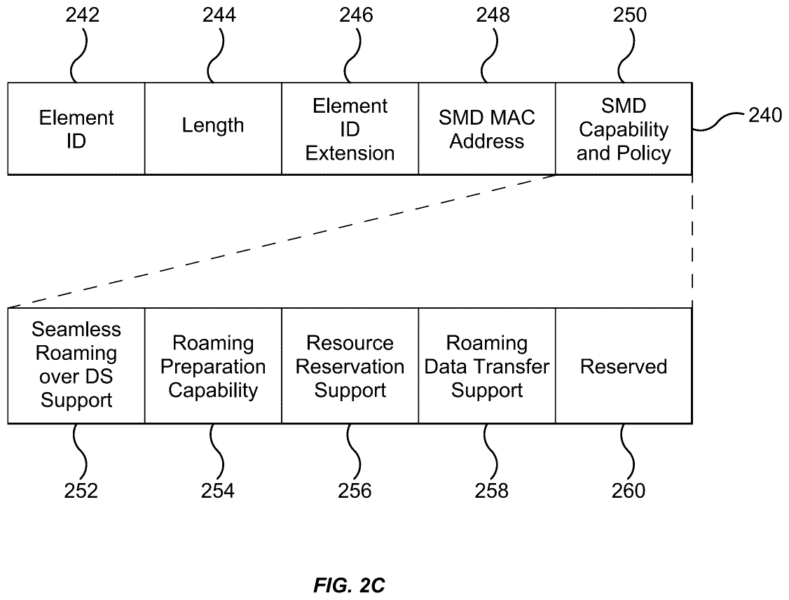

FIG. 2A illustrates an example operation 200 performed by the system 100 of FIG. 1A. The operation 200 may be performed by different components of the system 100, such as the network management entity 102, access points 104, and the device 110. By performing the operation 200, the system 100 generates PMKs-R1 for access points in an SMD.

The access point 104A may broadcast or communicate information about the access point 104A in a beacon or probe response at 201. The access point 104A may also include in the beacon or probe response information about the SMD 106 and the FT MD to which the access point 104A is assigned. For example, the beacon or probe response may also include identifiers (e.g., media access control (MAC) addresses) for the SMD 106 and the FT MD. When the device 110 attempts to associate with the access point 104A, the device 110 generates and communicates a request 202 to the access point 104A. The request 202 may also include the identifiers for the SMD 106 and the FTMD, indicating that the device 110 is requesting to connect to the access point 104A, the SMD 106, and the FT MD. The access point 104A may be physically closest to the device 110, and the device 110 may communicate the request 202 to the access point 104A to connect to the access point 104A. As an example, the request 202 may be an association request or a reassociation request.

The network management entity 102 may detect that the device 110 is requesting to connect to the access point 104A, the SMD 106, and/or the FT MD. For example, the access point 104A may signal to the network management entity 102 that the device 110 is requesting access and send the information in the association request to the network management entity 102. In response, the network management entity 102 generates a PMK-R0 204 for the device 110. In some embodiments, the network management entity 102 first generates a master session key (MSK) for the device 110. The network management entity 102 then generates the PMK-R0 204 for the device 110 using the MSK.

The access point 104A then establishes a PMK-R1 for the access point 104A. First, the network management entity 102 generates a PMK-R1 206 for the access point 104A using the PMK-R0 204. The network management entity 102 then communicates the PMK-R1 206 to the access point 104A and/or installs the PMK-R1 206 on the access point 104A (e.g., when the access point 104A fetches the PMK-R1 206). The access point 104A generates a PTK 208 using the PMK-R1 206. The access point 104A may then use the PTK 208 to communicate with the device 110. For example, the access point 104A may use the PTK 208 to encrypt and/or decrypt communications with the device 110.

The access point 104A may be assigned to the SMD 106. For example, the SMD 106 may include access points distributed across a floor of a building. In the example of FIG. 2, the access point 104B may also be assigned to the same SMD 106 as the access point 104A. When the network management entity 102 determines that the device 110 is connecting to the access point 104A, the access point 104B may establish a PMK-R1 for the access point 104B. In the example of FIG. 2, the network management entity 102 generates a PMK-R1 210 using the PMK-R0 204, which may be the same as (e.g., matches) or different from the PMK-R1 206. The network management entity 102 then communicates the PMK-R1 210 to the access point 104B and/or installs the PMK-R1 210 on the access point 104B (e.g., when the access point 104B fetches the PMK-R1 210). The access point 104B may use the PMK-R1 210 when establishing communications for the device 110. In this manner, both the access points 104A and 104B establish PMKs-R1 even though the device 110 is not connected to every access point 104 in the SMD 106 (e.g., the access point 104B).

The PMK-R1 206 and the PMK-R1 210 may be generated using any suitable information. For example, the PMK-R1 206 and the PMK-R1 210 may be generated using the PMK-R0 204, an identifier for the SMD 106 (e.g., a MAC address or name of the SMD 106), an identifier for the FT MD (e.g., a MAC address or name of the FT MD), an identifier for the device 110, etc.

In some embodiments, the PMK-R1 206 and the PMK-R1 210 are associated with the SMD 106 rather than with the access points 104A and 104B. As a result, the PMK-R1 206 and the PMK-R1 210 are identical and may be generated using the identifier for the SMD 106, which links the PMK-R1 206 and the PMK-R1 210 to the SMD 106. For example, the PMK-R1 206 and the PMK-R1 210 may be generated using the identifier for the SMD 106 (e.g., a MAC address or name of the SMD 106) and/or a PMK-R0 (e.g., of the FT MD). In these instances, the PTKs 308A and 308B may be considered as being part of a single PTK security association established for the device 110 and/or for the SMD 106. The PTKs 308A and 308B may be identified using different key identifiers. Other SMDs of the FT MD may use separate PMKs-R1 for the access points of those SMDs. The PMKs-R1 for these SMDs may be installed or established on the access points of these SMDs (e.g., when fetched by these access points).

After the initial association, the access point 104A and the other access points that are part of the FT MD have a PMK-R1 installed (e.g., generated by the network management entity 102 using the PMK-R0 of the FT MD) or the PMK-R1 may be fetched by the access points.

In certain embodiments, the network management entity 102 generates a PMK-R1 for the SMD 106 (e.g., the SMD PMK-R1) that is used for the access points 104 of the SMD 106. The SMD PMK-R1 may be generated using the PMK-R0 of the FT MD and an identifier for the SMD 106 (e.g., the MAC address of the SMD 106). The SMD PMK-R1 may be installed on the access points of the SMD 106, or the access points of the SMD 106 may fetch the SMD PMK-R1 from the network management entity 102. For access points in another SMD but in the same FT MD, the network management entity 102 may generate a separate SMD PMK-R1 for these access points. The separate SMD PMK-R1 may be installed on or fetched by these access points. As a result, access points in the same FT MD may still have separate PMK-R1 specific to the access points as generated in the case of FT roaming, which may allow a client device to perform FT roaming between the access points if desired.

In some embodiments, the network management entity 102 generates a separate SMD PMK-R1 for each SMD that is part of the FT MD. The SMD PMK-R1 for an SMD is generated using the PMK-R0 of the FT MD and an identifier for that SMD (e.g., the SMD MAC address). The SMD PMK-R1 of an SMD may be installed on or fetched by the access points of that SMD.

FIG. 2B illustrates an example message 220 used in the system 100 of FIG. 1A. Generally, the message 220 may be included in a beacon or probe response communicated by an access point, or the message 220 may be included in a request (e.g., association request or reassociation request) communicated by a device attempting to connect to the access point.

As seen in FIG. 2B, the message 220 includes an SMD identifier 222 and an FT MD identifier 224. The SMD identifier 222 may identify an SMD to which an access point belongs, and the FT MD identifier 224 may identify an FT MD to which the access point belongs. For example, the SMD identifier 222 may include a MAC address of the SMD or a name of the SMD, and the FT MD identifier 224 may include a MAC address of the FT MD or a name of the FT MD.

In some embodiments, the message 220 is included in a beacon or probe response communicated by an access point. The access point may communicate the beacon or probe response to inform devices in the vicinity of the access point how to connect to the access point. Additionally, the beacon or probe response may indicate that connecting to the access point will also result in connecting to the SMD and the FT MD.

The message 220 may be included in a request (e.g., an association request or reassociation request) from a device. The device may communicate the request to an access point to request a connection with the access point. Additionally, the request may identify the SMD and the FT MD to which the access point belongs. The access points in the SMD and FT MD may then establish PMKs-R1. For example, the access point may direct information in the request to a network management entity to inform the network management entity that the device is attempting to connect to the access point, the SMD, and/or the FT MD. The network management entity may use that information to generate keys for the device. For example, the network management entity may generate a PMK-R0 for the device, and the network management entity may use the PMK-R0 to generate PMKs-R1 for the access points in the SMD. The network management entity may then communicate and/or install the PMKs-R1 to the access points in the SMD.

In some instances, the SMD identifier 222 may be included in an element called an SMD element. FIG. 2C illustrates an example message 240 used in the system 100 of FIG. 1A. The message 240 may be an SMD element. As seen in FIG. 2C, the SMD element includes portions indicating different information. For example, a portion 242 may indicate an element identifier, which may include values (e.g., one octet) that identify the message 240 as an SMD element. A portion 244 may include values (e.g., one octet) that indicate a length of the SMD element. A portion 246 may provide an extension (e.g., one octet) for the element identifier. A portion 248 may indicate a MAC address of the SMD (e.g., using six octets), which may serve as an identifier for the SMD. A portion 250 may include values (e.g., one octet) indicating capabilities and policies of the SMD.

The portion 250 may include portions with different values indicating the capabilities and policies of the SMD. For example, a portion 252 (e.g., one bit) indicates whether the SMD supports seamless roaming over the DS. A portion 254 (e.g., one bit) indicates whether the SMD can perform roaming preparation. A portion 256 (e.g., one bit) indicates whether the SMD supports resource reservation. A portion 258 (e.g., one bit) indicates whether the SMD supports roaming data transfer. A portion 260 (e.g., four bits) may be reserved for future use.

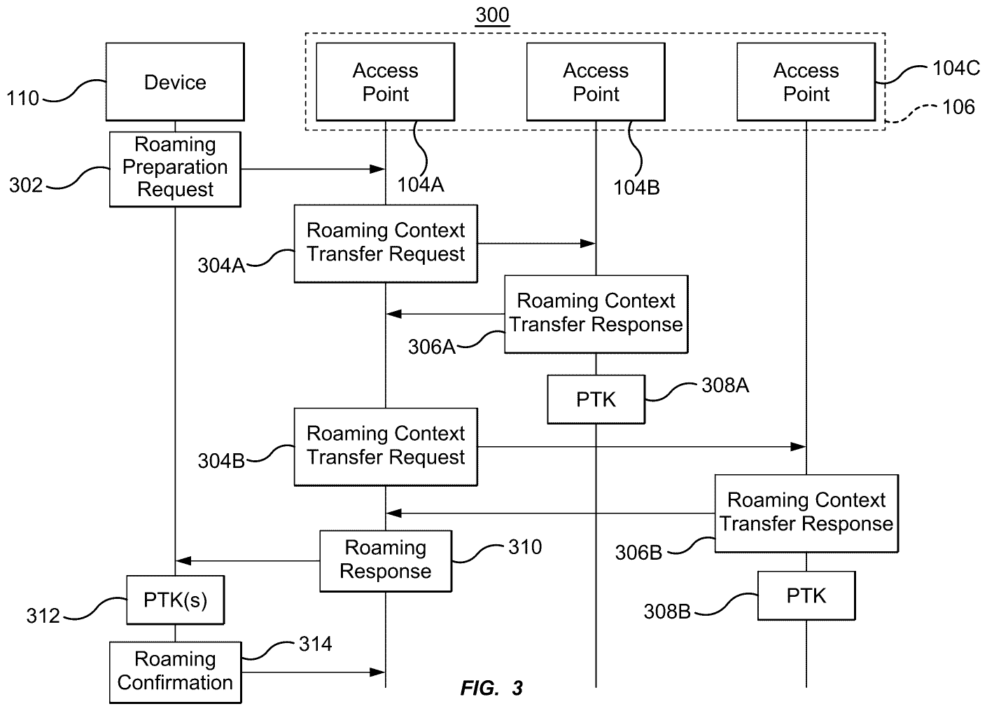

FIG. 3 illustrates an example operation 300 performed by the system 100 of FIG. 1A. The operation 300 may be performed by different components of the system 100, such as the access points 104 and the device 110. By performing the operation 300 (which may also be referred to as the roaming preparation phase), the system 100 prepares access points in an SMD for the device roaming to the access points.

The device 110 begins by generating and communicating a roaming preparation request 302 (which may also be referred to as a roaming notification request or roaming request) to the access point 104A. The roaming preparation request 302 indicates to the access point 104A that the device 110 will be roaming to another access point in the system 100 (e.g., because the signal strength between the device 110 and the access point 104A is weakening due to movement of the device 110). As seen in FIG. 3, the access point 104A is assigned to an SMD 106 along with access points 104B and 104C. The access point 104A may prepare the access points 104B and 104C so that the device 110 can roam seamlessly to the access points 104B and 104C.

The roaming preparation request 302 may indicate to the access point 104A that the device 110 will be roaming to another access point. The roaming preparation request 302 may include a list of candidate access points to which the device 110 may roam. In the example of FIG. 3, the roaming preparation request 302 may identify the access point 104B and the access point 104C as candidates for roaming. Additionally, the roaming preparation request 302 may include nonce values (which may be referred to as SNonces) that the candidate access points may use to generate PTKs for communicating with the device 110. For example, the roaming preparation request 302 may include tuples that each identify a candidate access point and provide a SNonce for the candidate access point to use.

The access point 104A generates and communicates roaming context transfer requests 304 to the candidate access points to signal to the candidate access points to prepare for the device 110 to roam to the candidate access points. The roaming context transfer requests 304 may be communicated from the access point 104A to the candidate access points wirelessly or through the network management entity (which may be referred to as communicating over the distribution system (DS)). Each roaming context transfer request 304 may identify the device 110, the SMD 106, and the FT MD. Each roaming context transfer request may also include the SNonce that the candidate access point should use to generate PTKs for the device 110. In some embodiments, the roaming preparation request 302 also includes an identifier for the network management entity (such as an R0 keyholder identifier (R0KH-ID) or a pairwise master key R0 name (PMKR0Name)).

In the example of FIG. 3, the roaming preparation request 302 may identify the access points 104B and 104C as candidate access points for roaming. In response, the access point 104A generates and communicates a roaming context transfer request 304A to the access point 104B. The roaming context transfer request 304A may identify the device 110, the SMD 106, and the FT MD. The roaming context transfer request 304A may also include the SNonce that the access point 104B should use to generate a PTK for communicating with the device 110. The access point 104A also generates and communicates a roaming context transfer request 304B to the access point 104C. The roaming context transfer request 304B may identify the device 110, the SMD 106, and the FT MD. The roaming context transfer request 304B may also include the SNonce that the access point 104C should use to generate a PTK for communicating with the device 110. The SNonce communicated to the access point 104B may be different from the SNonce communicated to the access point 104C. In some embodiments, the roaming context transfer requests 304 also include identifiers for the network management entity (e.g., R0KH-ID and PMKR0Name).

In some embodiments, the access point 104A communicates the roaming context transfer request 304A to the access points in the SMD 106. For example, the access point 104A may determine that the roaming preparation request 302 identifies the SMD 106 and the FT MD, and in response, the access point 104A communicates the roaming context transfer request 304A to the access points assigned to the SMD 106 and the FT MD.

The candidate access points generate and communicate roaming context transfer responses 306 back to the access point 104A. The roaming context transfer responses 306 may include nonce values (which may be referred to as ANonces). In some embodiments, the candidate access points generate respective ANonces (e.g., using an authenticator and/or the respective SNonces). The roaming context transfer responses 306 may also indicate whether the respective context transfer was successful or failed. Additionally, the roaming context transfer responses 306 may include respective SNonces used by the candidate access points, identifiers for the candidate access points (which may also be referred to as R1 keyholder identifiers (R1KH-IDs)), and R0KH-ID.

In the example of FIG. 3, the access point 104B generates and communicates a roaming context transfer response 306A to the access point 104A. The roaming context transfer response 306A may include an ANonce for the access point 104B. The access point 104C communicates a roaming context transfer response 306B to the access point 104A. The roaming context transfer response 306B may include an ANonce for the access point 104C, which may be different from the ANonce for the access point 104B.

The access point 104A uses the information in the roaming context transfer responses 306 to generate a roaming response 310 (which may also be referred to as a roaming notification response). The roaming response 310 may include the ANonces from the candidate access points. The access point 104A communicates the roaming response 310 to the device 110. In some embodiments, the roaming response 310 may also indicate whether the context transfer was successful or failed. Additionally, the roaming response 310 may include respective ANonces from the candidate access points, R1KH-IDs, and R0KH-ID.

In the example of FIG. 3, the access point 104A generates the roaming response 310 using the information in the roaming context transfer responses 306A and 306B. For example, the roaming response 310 may include the ANonces for the access points 104B and 104C. The roaming response 310 may also identify the access points 104B and 104C and may include message integrity codes from the access points 104B and 104C. The roaming response 310 may also include elements that identify the SMD 106 and/or the FT MD. The access point 104A then communicates the roaming response 310 to the device 110.

The candidate access points may also generate PTKs using the SNonces in the roaming context transfer requests 304. In the example of FIG. 3, the access point 104B generates a PTK 308A using the SNonce in the roaming context transfer request 304A and the PMK-R1 that the access point 104B previously established (e.g., using the network management entity) when the device 110 associated with the access point 104A (e.g., in the operation 200 shown in FIG. 2). The access point 104C generates a PTK 308B using the SNonce in the roaming context transfer request 304B and the PMK-R1 that the access point 104C previously established (e.g., using the network management entity) when the device 110 associated with the access point 104A. The access points 104B and 104C may use the PTKs 308A and 308B to communicate with the device 110 (e.g., to encrypt or decrypt communications with the device 110) if the device 110 subsequently roams to the access points 104B and 104C. The access points 104B and 104C may also use the PTKs 308A and 308B to generate message integrity codes. In some embodiments, the PTKs 308A and 308B may be generated using one or more of the previously established PMKs-R1, SNonce, ANonce (e.g., generated by an authenticator at the access point), the MAC address of the device 110, and/or the MAC address of the access point.

In certain embodiments, a single PTK security association (PTKSA) may be established for the client device 110 for the SMD 106 (e.g., across all access points of the SMD 106). The PTK for one access point may be identified with a different key identifier than the PTK for another access point within the PTKSA (or multiple instances of PTKSA may be maintained, one per key identifier).

In some embodiments, the access points 104B and 104C use other information to generate the PTKs. For example, the access points 104B and 104C may also use respective ANonces, an identifier for the device 110 (e.g., the MAC address of the device 110), respective identifiers for the access points 104B and 104C (e.g., the MAC addresses of the access points 104B and 104C), an identifier for the SMD 106 (e.g., the MAC address of the SMD 106 or an identifier of the SMD 106), and/or the identifier for the FT MD (e.g., the MAC address of the FT MD or an identifier of the FT MD).

Additionally, the device 110 generates PTKs 312 using the information in the roaming response 310. For example, the device 110 may use the R1KH-ID for a candidate access point to generate the PMK-R1 for that candidate access point. The device 110 may then use that PMK-R1, the ANonce for that candidate access point, the SNonce for that candidate access point, the identifier for that candidate access point (e.g., the MAC address for that candidate access point), and the identifier for the device 110 (e.g., the MAC address for the device 110) to generate a PTK for communicating with the candidate access point. In some embodiments, the device 110 may also use the identifier for the SMD 106 (e.g., the MAC address for the SMD 106) to generate the PTK.

In the example of FIG. 3, the device may generate a first PTK for communicating with the access point 104B using the ANonce for the access point 104B in the roaming response 310. The device may also generate a second PTK for communicating with the access point 104C using the ANonce for the access point 104C in the roaming response 310. The device 110 may use the first and second PTKs if the device 110 subsequently roams to the access points 104B and 104C.

In this manner, the device 110 and the access points 104B and 104C prepare for the device 110 roaming by pre-generating PTKs for communicating with each other, which may reduce transition times and delays when the device 110 roams.

In some embodiments, the access point 104A includes a message integrity code (MIC) in the roaming response 310 communicated to the device 110. The access point 104B may generate the MIC for the PTK 308A, and the MIC may verify the authenticity and/or integrity of the PTK 308A. The device 110 may verify the MIC based on the PTK 308A. After establishing the PTK 312, the device 110 may generate a roaming confirmation 314 and communicate the roaming confirmation 314 to the access point 104A. The roaming confirmation 314 may include a MIC generated by the device 110. The device 110 may generate the MIC based on the PTK 308A (and/or PTKs of other candidate access points). The access point 104A may forward the MIC to the access points 104B and 104C, and the access point 104B or 104C may verify the MIC. In some instances, the MIC can be exchanged by the device 110 and the access point 104B or 104C after the device 110 roams to the access point 104B or 104C.

The SNonces and ANonces (in this embodiment and other embodiments) may be any suitable value. For example, the SNonces and ANonces may be cryptographic nonce values. As another example, the SNonces and ANonces may be public keys (e.g., Diffie-Hellman public keys) for the device 110 and/or the access points 104. If the SNonces and ANonces are public keys, then the PTKs may be generated by first generating a shared secret using a public key and a private key. Then, the PTK may be generated using the shared secret. As an example, the device 110 may include a public key in the roaming request 302, and the access point 104A may include the public key in the roaming context transfer request 304A. The access point 104B may use the public key and a private key to generate a shared secret. The access point 104B may then use the shared secret to generate the PTK 308A.

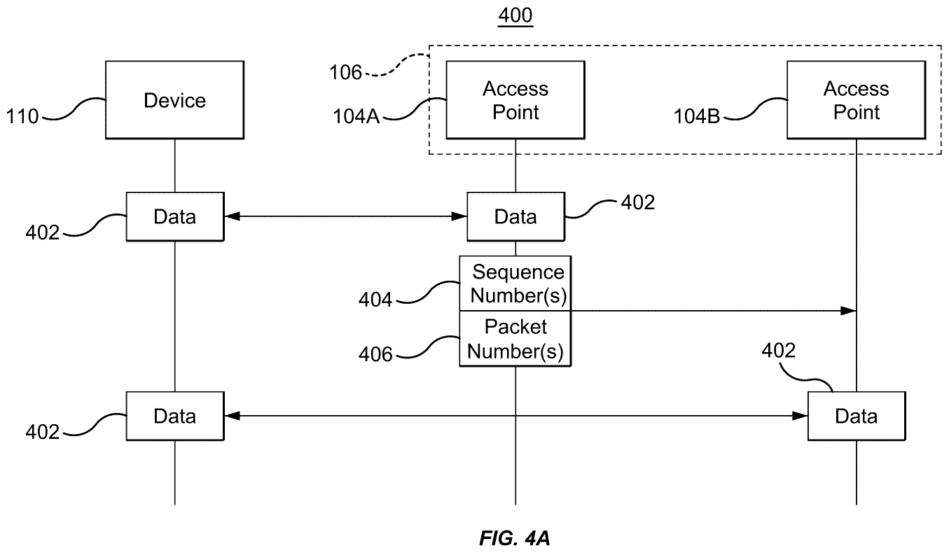

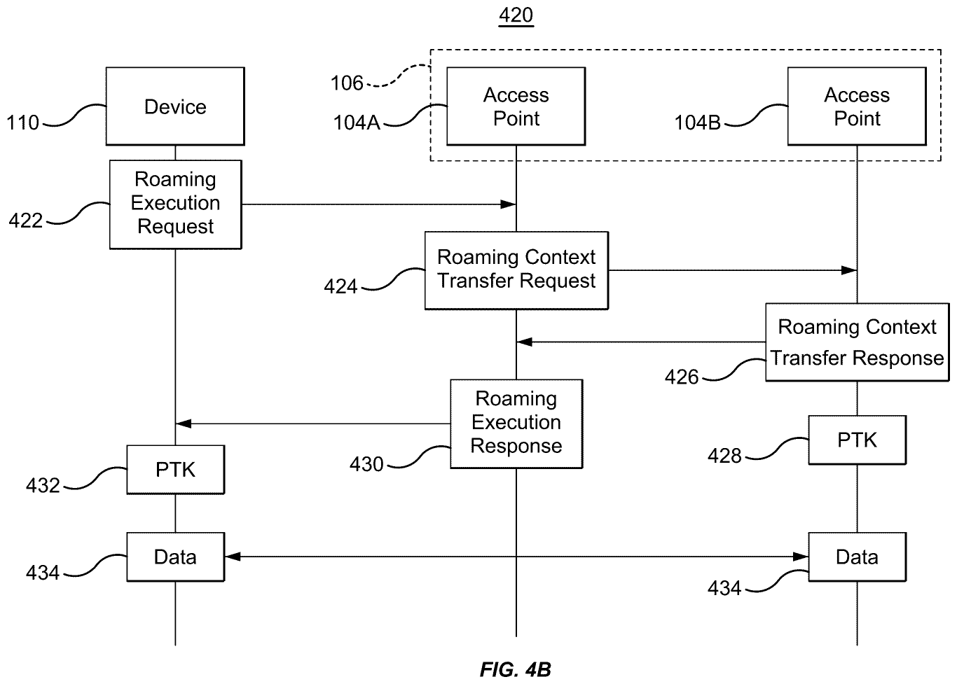

FIG. 4A illustrates an example operation 400 performed by the system 100 of FIG. 1A. The operation 400 may be performed by different components of the system 100, such as the access points 104 and the device 110 after the operation 300 is performed. By performing the operation 400 (which may also be referred to as the roaming execution phase), the device 110 may roam to another access point 104.

As seen in FIG. 4A, the device 110 and the access point 104A begin by communicating data 402 with each other. The exchange of data 410 may include communicating packets between the device 110 and the access point 104A. The device 110 and/or the access point 104A may determine that the device 110 will roam to the access point 104B (e.g., because the signal strength between the device 110 and the access point 104B is better than the signal strength between the device 110 and the access point 104A). In response the device 110 and the access point 104A may stop communicating the data 402.

The access point 104A then hands off the connection with the device 110 to the access point 104B, which is in the same SMD 106 as the access point 104A. As part of the handoff, the access point 104A communicates one or more sequence numbers 404 and one or more packet numbers 406 to the access point 104B. The sequence numbers 404 and the packet numbers 406 may indicate to the access point 104B how to resume exchanging data 402 with the device 110. For example, the sequence numbers 404 may be the last sequence numbers for data 402 communicated between the device 110 and the access point 104A, and the packet numbers 406 may be the last packets of data 402 communicated between the device 110 and the access point 104A. As another example, the sequence numbers 404 may be the sequence numbers for data 402 that the access point 104B should begin using with the device 110, and the packet numbers 406 may be the packet of data 402 that the access point 104B should begin using with the device 110. After handing off the connection, the device 110 and the access point 104B may resume communicating the data 402 according to the sequence numbers 404 and the packet numbers 406. In this manner, the communication of data 402 is not interrupted from the perspective of the device 110.

Additionally, the device 110 and the access point 104B may communicate the data 402 with each other using the PTKs generated for the device 110 and the access point 104B (e.g., the PTKs 308B and 312 shown in FIG. 3). Because the device 110 and the access point 104B previously generated these PTKs during the roaming preparation phase (e.g., the operation 300 shown in FIG. 3), the device 110 and the access point 104B need not generate these PTKs during the roaming execution phase (e.g., the operation 400 shown in FIG. 4A). Rather, the device 110 may quickly roam to the access point 104B without the access point 104B and the device 110 needing to perform the handshake or data exchange needed to generate PTKs, which may reduce the transition time and delay of the handoff.

In some instances, the device and the access points may not have time or opportunity to perform both the roaming preparation phase and the roaming execution phase. For example, if the signal strength between the device and an access point dropped significantly and suddenly, then the device and the access points may not have time or opportunity to perform the handshake and/or data exchange of the roaming preparation phase. Instead, the device and the access points may perform a different operation to generate PTKs during roaming. FIG. 4B illustrates an example operation 420 performed by the system 100 of FIG. 1A. The operation 420 may be performed by different components of the system 100, such as the access points 104 and the device 110. By performing the operation 420, the device 110 may roam to another access point 104 when the device 110 does not have opportunity to perform the roaming preparation phase.

The device 110 may be communicating with the access point 104A when the signal strength between the device 110 and the access point 104A suddenly weakens. The device 110 may detect that the signal strength between the device 110 and the access point 104B, however, is strong enough to support a connection. Thus, the device 110 may determine that the device 110 should roam to the access point 104B. The device 110 and the access point 104B, however, may not have performed the roaming preparation phase and established PTKs for communicating with each other.

The device 110 generates and communicates a roaming execution request 422 to the access point 104A. The roaming execution request 422 may identify the device 110, the access point 104B, the SMD 106, and the FT MD to which the access point 104A and/or the access point 104B belong. Additionally, the roaming execution request 422 may include an identifier for the network management entity (e.g., R0KH-ID). The roaming execution request 422 may also include an SNonce for the access point 104B.

The access point 104A generates a roaming context transfer request 424 and communicates the roaming context transfer request 424 to the access point 104B. The roaming context transfer request 424 may be communicated wirelessly to the access point 104B or through the network management entity (e.g., over the DS) to the access point 104B. The roaming context transfer request 424 may identify the device 110, the access point 104B, the SMD 106, and the FT MD. The roaming context transfer request 424 may also include the SNonce and the context for communications between the device 110 and the access point 104A. For example, the context may include last sequence number and packet number communicated between the access point 104A and the device 110. The roaming context transfer request may also include an identifier for the network management entity (e.g., R0KH-ID).

The access point 104B receives the roaming context transfer request 424 and generates a roaming context transfer response 426. The roaming context transfer response 426 may identify the device 110, the access point 104B, the SMD 106, and the FT MD. The roaming context transfer response 426 may also indicate the status of the context transfer (e.g., success or fail) and may include group keys, the SNonce, and an ANonce generated by the access point 104B (e.g., using an authenticator at the access point 104B). The roaming context transfer response 426 may also include an identifier for the access point 104B (e.g., R1KH-ID) and an identifier for the network management entity (e.g., R0KH-ID).

The access point 104B also uses information in the roaming context transfer request 424 to generate a PTK 428 for communicating with the device 110. For example, the access point 104B may use a PMK-R1 provided by the network management entity, the SNonce, the ANonce, an identifier for the device 110 (e.g., the MAC address for the device 110), and an identifier for the access point 104B (e.g., the MAC address for the access point 104B) to generate the PTK 428. In some embodiments, the access point 104B also uses an identifier for the SMD 106 (e.g., the MAC address for the SMD 106) to generate the PTK 428.

The access point 104A receives the roaming context transfer response 426 and generates a roaming execution response 430. The roaming execution response 430 may identify the access point 104B, the SMD 106, and the FT MD and may include a status of the context transfer (e.g., success or fail). The roaming execution response 430 may also include group keys, the SNonce, the ANonce, an identifier for the access point 104B (e.g., R1KH-ID), and an identifier for the network management entity (e.g., R0KH-ID). The access point 104A communicates the roaming execution response 430 to the device 110.

The device 110 generates a PTK 432 using the information in the roaming execution response 430. For example, the device 110 may use the R1KH-ID for the access point 104B to generate the PMK-R1 for the access point 104. The device 110 may then use that PMK-R1, the ANonce for the access point 104B, the SNonce for the access point 104B, the identifier for the access point 104B (e.g., the MAC address for the access point 104B), and the identifier for the device 110 (e.g., the MAC address for the device 110) to generate the PTK 432 for communicating with the access point 104B. In some embodiments, the device 110 may also use the identifier for the SMD 106 (e.g., the MAC address for the SMD 106) to generate the PTK 432.

After the device 110 generates the PTK 432, the connection may be handed off to the access point 104B, and the device 110 and the access point 104B may begin communicating data 434 with each other. The device 110 and the access point 104B may communicate the data 434 from the last sequence number and packet number that were communicated between the access point 104A and the device 110. The device 110 may use the PTK 432 to encrypt or decrypt communications between the access point 104B and the device 110, and the access point 104B may use the PTK 428 to encrypt or decrypt communications between the access point 104B and the device 110.

In some embodiments, any identifiers for the access points 104, device 110, network management entity, SMD, and FT MD may be used. For example, MAC addresses, R0KH-ID, and R1KH-ID may be used. As another example, a reconfiguration multi-link element (e.g., a per-station profile sub-element) may be used to indicate an access point or access point link.

The operation 420 shown in FIG. 4B may resemble the operation 300 shown in FIG. 3A. Generally, the roaming request 302 shown in FIG. 3A may be a roaming preparation request, a roaming transition request, the roaming execution request 422, an FT request frame, a link reconfiguration request frame, a link reconfiguration notify frame, or another management frame.

In instances where a device 110 requests to roam from a first access point in a first SMD to a second access point in a second SMD, the device 110 may use FT roaming. For example, if the device determines from SMD and FT MD identifiers that the second access point belongs in the second SMD, which is in the same FT MD as the first SMD, then the device may use FT roaming to roam from the first access point to the second access point. The second access point may establish association for the device 110 with the second SMD as part of the FT roaming to the second access point. A request or response frame used for the FT roaming may include an identifier for the second SMD. As a result, FT roaming may be used to roam across two non-contiguous SMDs of an extended service set.

Some network deployments do not use the FT framework, which means these networks may use the R0 and R1 key hierarchy discussed above. These deployments may use slightly altered approaches to roaming.

In a first approach, the network defines an R0 and R1 hierarchy for seamless roaming, like in the FT framework. This hierarchy may include the R0KH and the R1KH. As part of initial association to the SMD, the R0KH generates PMK-R0 and separate PMKs-R1 for each of the access points that belong to the SMD. The R0KH then installs these PMKs-R1 on respective access points of the SMD. With this process, after the initial association to an SMD, the access points of the SMD have PMK-R1 installed or can fetch PMK-R1 from a key store.

During the roaming preparation phase or the roaming execution phase, the same procedure and the flow can be executed as discussed above to generate PTKs for access points in the SMD. The signaling in the roaming process may not identify an FT MD because no FT MD is deployed in the network. The signaling may still include ANonce, SNonce, R0KH-ID, R1KH-ID and R0Name to enable PTK generation.

Each access point may have a PMK-R1 installed or be able to fetch a PMK-R1 from a key store so that a PTK can be locally generated using the PMK-R1. The same PMK-R1 may or may not be shared among multiple access points of an SMD.

In a second approach, a PMK generated at the time of initial SMD association is considered to be a PMK between the device and the SMD. Hence, this PMK can be shared and used across access points of an SMD. In this key architecture, the R0 and R1 key hierarchy is not needed. The serving access point at the time of initial SMD association can either install the PMK on all the access points of an SMD, or the PMK is stored in a key store, where it can be fetched by the access points of the SMD. The PMK is stored with a PMKSMDName as part of the context for the PMK to be retrieved later.

During the roaming preparation phase or the roaming execution phase, the signaling may be simplified and does not include the R0KH-ID and R1KH-ID. Instead, the device and the serving access point may include PMKSMDName in the request message. The SMD Context Transfer Request to the target access point with PMKSMDName indicates to the target access point which PMK to use for generating the PTK. The target access point will use the PMK corresponding to the PMKSMDName to generate the PTK for the target access point. The device uses the same PMK to generate the PTK for each target access point.

In some embodiments, when a device roams from a first access point in a first SMD to a second access point in a second SMD in the same FT MD, then the device performs FT roaming. In this case, the device performs an association to the second SMD to be able to later perform seamless roaming between access points of the second SMD. For example, the client device may perform a full initial SMD association with the second SMD when roaming between the first and second access points that are part of different SMDs. However, performing a full authentication (e.g. either 802.1X EAP authentication or SAE or PSK authentication) may add delay when performing roaming between the two access points.

The FT roaming may be enhanced such that when the FT roaming is performed between the two access points that are part of different SMDs, the FT roaming also supports SMD association and generation of SMD specific keys (e.g., PMK R1 and PTK).

The FT request frame may include a field or element that indicates an identifier for the SMD (e.g. an SMD MAC address or a name of the SMD) corresponding to the target access point for the FT roaming. The inclusion of this field or element indicates the device's intention to associate with the different SMD. When the target access point receives the FT request (e.g., over-the-DS), the target access point identifies the PMK-R0 corresponding to the device (e.g. based on the R0KH-ID and/or PMKR0Name fields received in the FT request). The target access point may then determine if a PMK-R1 for the device was previously established. If not, the target access point may fetch or request to generate a PMK-R1 for the device from the R0KH (e.g., the network management entity). The PMK-R1 can be a PMK-R1 for the SMD or for the target access point, based on the PMK-R1 key hierarchy defined for the SMD.

The target access point may generate the PTK based on the PMK-R1 corresponding to the target access point (e.g., along with SNonce and ANonce values). The FT response frame sent by the target access point may also include the field or element that indicates the identifier for the SMD. Similarly, when the FT roaming protocol is executed over-the-air, the authentication-request and authentication-response frames may include the field or element that indicates the identifier for the SMD corresponding to the target access point for the FT roaming. The target access point may use the PMK-R1 of the device to generate the PTK. The PMK-R1 may be associated with the SMD or the target access point, based on the PMK-R1 key hierarchy defined for the SMD.

Similarly, the request (e.g., reassociation request) sent by the device for FT roaming may also include the field or element that indicates the identifier for the SMD (e.g. an SMD MAC Address or a name for the SMD). The inclusion of this field or element indicates the device's intention to also associate with the SMD. The request sent by the target access point may also include the field or element indicating the identifier for the SMD.

After a successful exchange of request and response frames for FT roaming with the target access point (that is part of a different SMD than the current/serving access point), the device may be associated with the SMD corresponding to the target access point. The device may later roam between the access points that are part of the SMD corresponding to the target access point using the seamless roaming procedure.

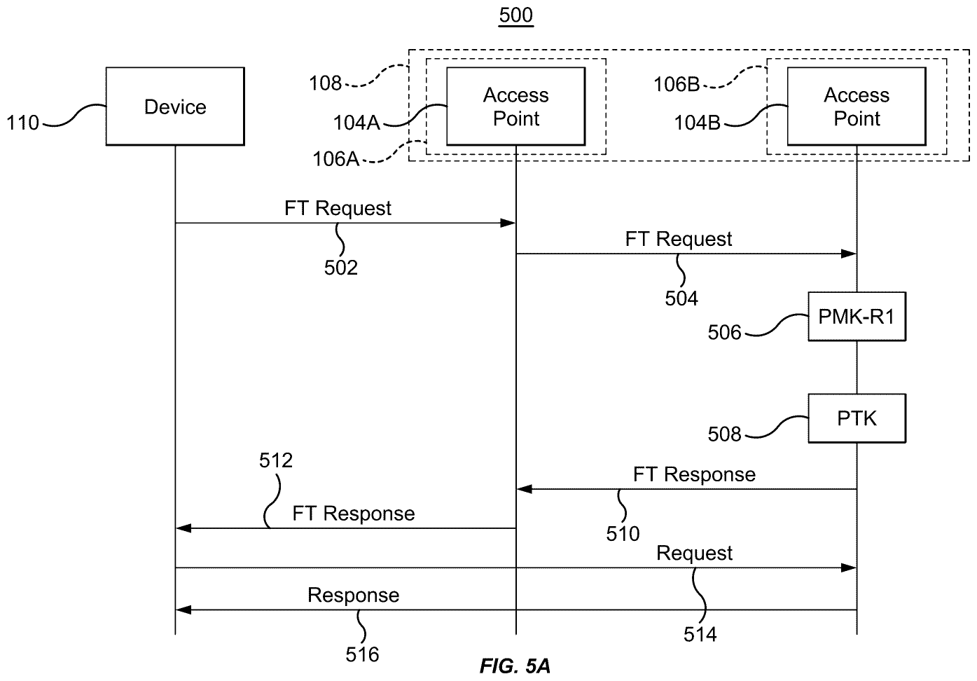

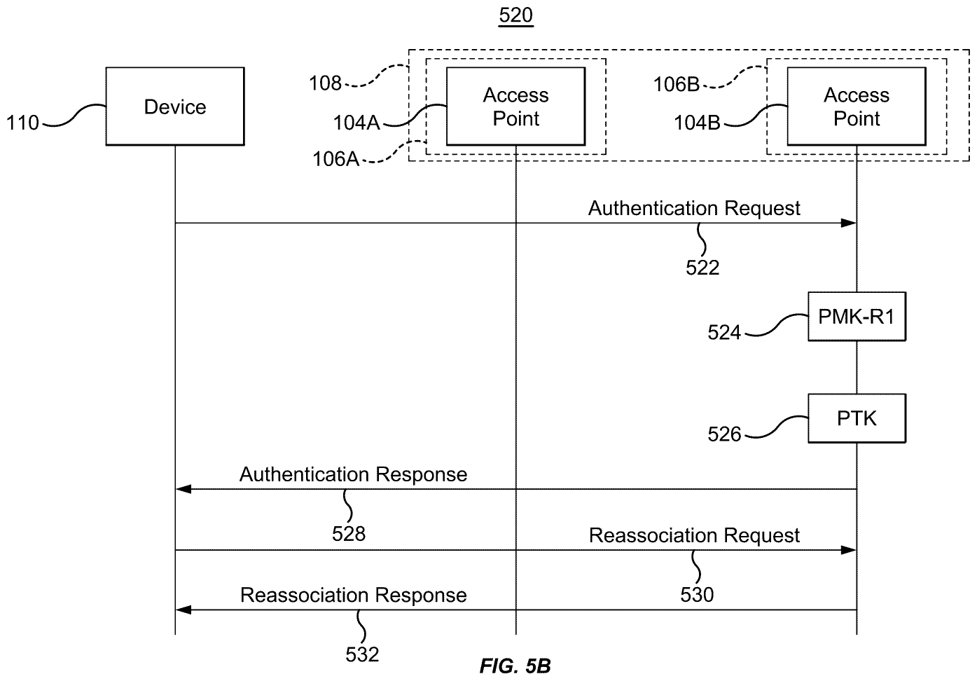

FIGS. 5A and 5B illustrate example operations 500 and 520, respectively, performed by the system 100 of FIG. 1A. Generally, the operations 500 and 520 involve FT roaming between two access points that are part of different SMDs and the same FT MD. In the operation 500, FT roaming is performed using FT over-the-DS protocol. In the operation 520, FT roaming is performed using FT over-the-air protocol.

The device 110 begins the operation 500 by communicating a FT request to the access point 104A at 502. The access point 104A may be a serving access point for the device 110. The access point 104A is assigned to the SMD 106A. At 504, the access point 104A communicates the FT request to the access point 104B (e.g., over-the-DS). The access point 104B is assigned to the SMD 106B, which is in the same FT MD 108 as the SMD 106A. The FT request may include any information that the access point 104B may use to establish a PMK-R1 and/or to generate a PTK. For example, the FT request may include an identifier for the access point 104B (e.g., a MAC address or name of the access point 104B), a SNonce, etc. The FT request may also include the field or element that identifies the SMD 106B.

The access point 104B establishes a PMK-R1 506 for the device 110 upon receiving the FT request over-the-DS if the PMK-R1 506 was not already established (e.g. as part of initial association to the FT MD 108 and the SMD 106A or 106B). The PMK-R1 506 could be specific to the access point 104B, or the PMK-R1 506 could be specific to the SMD 106B (in which case, the PMK-R1 506 is the same for all access points in the SMD 106B). The PMK-R1 506 may be different for different access points and/or SMDs. If the PMK-R1 506 specific to the SMD 106B is used, then the access point 104B may request the PMK-R1 506 (e.g., from a network management entity) and establish a PMK-R1 for SMD 106A (if not already established). The access point 104B then generates a PTK 508 using the PMK-R1 506.

The device 110 may then communicate a request to the access point 104B at 514. This request may be a reassociation request. The request may include the field or element that includes the identifier for the SMD 106B, which may indicate to the access point 104B that the device 110 wants to associate with the SMD 106B. Additionally, the reassociation request may include a message integrity code. The access point 104B may then establish association with the device 110 with the access point 104B and with the SMD 106B. The access point 104B communicates a response to the device 110 in 516. The response may be a reassociation response that also includes the field or element that includes the identifier for the SMD 106B. Additionally, the response may include a message integrity code.

The operation 520 is similar to the operation 500 except the device 110 communicates over-the-air directly with the access point 104B (instead of communicating the FT request through the access point 104A). As seen in FIG. 5B, the device 110 communicates an authentication request to the access point 104B at 522. The access point 104B then generates a PMK-R1 524 and a PTK 526. The access point 104B then communicates an authentication response to the device 110 at 528.

The device 110 communicates a reassociation request to the access point 104B at 530, which may indicate a desire to associate with the access point 104B and the SMD 106B. The access point 104B then establishes association between the device 110 and the access point 104B and the SMD 106B. The access point 104B communicates a reassociation response to the device 110 at 532.

The authentication request, authentication response, reassociation request, and/or reassociation response may include the field or element that includes the identifier for the SMD 106B.

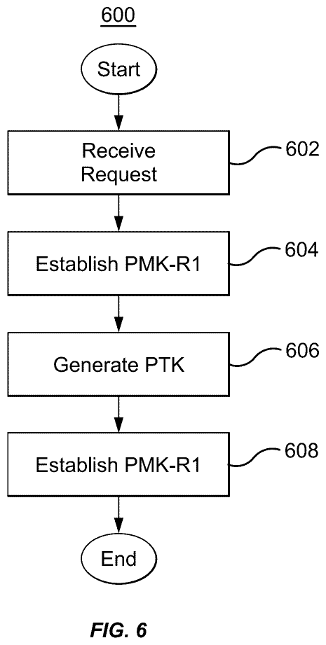

FIG. 6 is a flowchart of an example method 600 performed by the system 100 of FIG. 1A. In certain embodiments, different components of the system 100 perform the steps of the method 600. By performing the method 600, the system 100 implements seamless roaming using the FT framework, which may reduce transition times and delays when roaming.

At 602, a first access point receives a request from a device (e.g., a client device). The request may be a request to connect and communicate through the first access point. The first access point may be assigned to an SMD along with a second access point. For example, the first access point and the second access point may be positioned on the same floor of a building, and the SMD includes the access points positioned on that floor.

In response to the request, a network management entity may generate FT keys for the first access point and other access points in the SMD. The network management entity may generate an MSK for the device 110. The network management entity may then generate a PMK-R0 for the device. Using the PMK-R0, the network management entity generates PMKs-R1 for the access points in the SMD. For example, the network management entity may generate a first PMK-R1 for the first access point and a second PMK-R1 for the second access point. The network management entity then communicates the PMKs-R1 to respective access points in the SMD.

At 604, the first access point establishes the first PMK-R1. For example, the first access point may fetch and/or install the first PMK-R1 from the network management entity. At 606, the first access point uses the first PMK-R1 to generate a PTK for communicating with the device. For example, the first access point may use the PTK to encrypt and decrypt communications with the device. At 608, the second access point establishes the second PMK-R1. For example, the second access point may fetch and/or install the second PMK-R1 from the network management entity. The second access point may store the PMK-R1 for subsequent use if the device requests to roam to the second access point.

When the device indicates to the first access point that the device should roam to another access point in the SMD, the first access point may communicate roaming context transfer requests to other access points in the SMD. In response to the context transfer requests, the other access points may use respective PMKs-R1 from the network management entity to generate PTKs for communicating with the device. For example, the second access point may use the PMK-R1 from the network management entity to generate a PTK for communicating with the device. In this manner, the access points in the SMD are prepared with PTKs in case the device roams to these access points. When the device roams to the second access point, the first access point may hand off the connection to the second access point by communicating context information (e.g., sequence number and packet number) to the second access point. The device and the second access point need not perform the handshake or data exchange needed to establish PTKs, because the PTKs were previously established. As a result, transition times and delays are reduced, in certain embodiments.

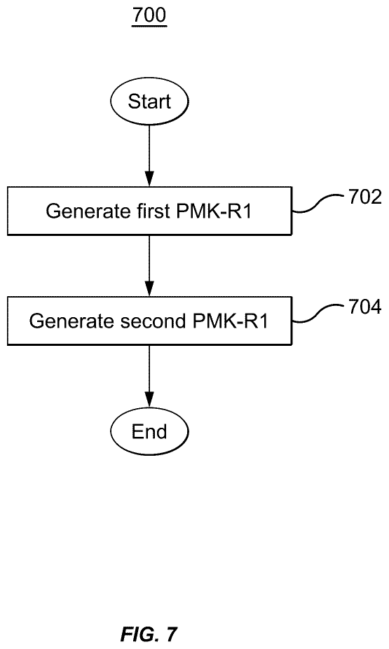

FIG. 7 is a flowchart of an example method 700 performed by the system 100 of FIG. 1A. In certain embodiments, a network management entity (e.g., the network management entity 102 shown in FIG. 1A) performs the method 700. By performing the method 700, the network management entity establishes PMKs-R1 for multiple access points assigned to an SMD in response to an association request from a device.

At 702, the network management entity generates a first PMK-R1 for a first access point. The first access point may inform the network management entity that a device communicated an association request to the first access point. The association request may identify an SMD and a FT MD to which the first access point is assigned. The network management entity may generate a MSK using the association request, and the network management entity may generate a PMK-R0 using the MSK. The network management entity then uses the PMK-R0 to generate a PMK-R1 for the first access point.

At 704, the network management entity generates a second PMK-R1 for a second access point. The second access point may also be assigned to the SMD and the FT MD. The network management entity may generate the second PMK-R1 for the second access point in response to determining that the association request identifies the SMD and that the second access point is assigned to the SMD. The network management entity may generate the second PMK-R1 using the PMK-R0. The second PMK-R1 may be different from the first PMK-R1. The network management entity may communicate the first PMK-R1 to the first access point and the second PMK-R1 to the second access point.

In summary, the wireless network implements a hierarchical seamless roaming technique to achieve seamless roaming using a FT framework. Generally, the access points in the network are assigned to groups called SMDs. Multiple SMDs are assigned to groups called FT MDs. An access point in an SMD may communicate information to other access points in the SMD such that the other access points establish PTKs for communicating with a client device that is associated with the access point. In this manner, the access points in the SMD are prepared to communicate with the client device before the client device roams to those access points.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Moreover, when elements of the embodiments are described in the form of “based on A,” it will be understood that embodiments based on at least A or based at least in part on A are contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless network comprising:
a first access point device assigned to a first seamless mobility domain (SMD) and a fast basic service set transition mobility domain (FT MD); and
a second access point device assigned to the first SMD and the FT MD, wherein the first access point device is configured to:
receive, from a client device, a request comprising (i) a first field identifying the FT MD and (ii) a second field identifying the first SMD;
establish, based on the request, a first pairwise master key R1 (PMK-R1) for the first access point device; and
generate, based on the request and the first PMK-R1, a first pairwise transient key (PTK) for the client device; and
wherein the second access point device is configured to establish, based on the request received by the first access point device identifying the first SMD and the FT MD and based on the second access point device being assigned to the first SMD and the FT MD, a second PMK-R1 for the second access point device.

2. The wireless network of claim 1, wherein:
the first access point device is configured to:
receive, from the client device, a roaming request indicating a request to roam to the second access point device; and
communicate, to the second access point device, a roaming context transfer request based on the roaming request; and
the second access point device is configured to:
generate a second PTK for the client device based on the roaming context transfer request and the second PMK-R1; and
communicate, to the first access point device, a roaming context transfer response based on the roaming context transfer request; and
the first access point device is configured to communicate, to the client device, a roaming response based on the roaming context transfer response.

3. The wireless network of claim 2, wherein communicating the roaming context transfer request to the second access point device is based on (i) the roaming request comprising a third field comprising an identifier for the first SMD and a fourth field comprising an identifier for the FT MD and (ii) the second access point device being assigned to the first SMD and the FT MD.

4. The wireless network of claim 3, wherein the second PTK is generated further based on the identifier for the first SMD.

5. The wireless network of claim 2, wherein the roaming response comprises a message integrity code generated by the second access point device based on the second PTK.

6. The wireless network of claim 2, wherein the roaming request comprises a public key for the client device and wherein the second PTK is generated based on the public key.

7. The wireless network of claim 6, wherein the second PTK is generated based on a shared secret generated based on the public key and a private key for the second access point device.

8. The wireless network of claim 2, wherein the roaming response comprises a public key for the second access point device.

9. The wireless network of claim 1, wherein the first PMK-R1 matches the second PMK-R1 and wherein the first PMK-R1 is generated based on the second field.

10. The wireless network of claim 1, wherein the second field comprises at least one of a media access control address for the first SMD or an identifier for the first SMD.

11. The wireless network of claim 1, further comprising a third access point device assigned to a second SMD and the FT MD, wherein the first access point is configured to perform FT roaming for the client device to roam to the third access point device from the first access point device or from the second access point device.

12. The wireless network of claim 11, wherein a third PMK-R1 for the second SMD is established as part of the FT roaming to the third access point device and wherein the third PMK-R1 is based on an identifier for the second SMD.

13. The wireless network of claim 11, wherein the third access point is configured to establish association for the client device with the second SMD as part of the FT roaming to the third access point.

14. The wireless network of claim 11, wherein at least one of a request or a response used for FT roaming include an identifier for the second SMD.

15. A wireless network comprising:
a first access point device assigned to a first SMD; and
a second access point device assigned to the first SMD, wherein the first access point device is configured to:
receive, from a client device, a request comprising a first field identifying the first SMD;
establish, based on the request, a first PMK-R1 for the first access point device; and
generate, based on the request and the first PMK-R1, a first PTK for the client device; and
wherein the second access point device is configured to establish, based on the request received by the first access point device identifying the first SMD and based on the second access point device being assigned to the first SMD, a second PMK-R1 for the second access point device.

16. The wireless network of claim 15, wherein the first PMK-R1 matches the second PMK-R1.

17. The wireless network of claim 15, wherein:
the first access point device is configured to:
receive, from the client device, a roaming request indicating a request to roam to the second access point device; and
communicate, to the second access point device, a roaming context transfer request based on the roaming request; and
the second access point device is configured to:
generate a second PTK for the client device based on the roaming context transfer request and the second PMK-R1; and
communicate, to the first access point device, a roaming context transfer response based on the roaming context transfer request; and
the first access point device is configured to communicate, to the client device, a roaming response based on the roaming context transfer response.

18. The wireless network of claim 17, wherein the roaming request comprises a public key for the client device and wherein the second PTK is generated based on the public key.

19. The wireless network of claim 17, wherein the second PTK is generated further based on an identifier for the first SMD.

20. The wireless network of claim 17, wherein the roaming response comprises a public key for the second access point device.

21. A wireless device comprising:
one or more memories; and
one or more processors communicatively coupled to the one or more memories, wherein the one or more processors are configured, individually or collectively, to perform an operation comprising:
communicating, to a first access point device assigned to a SMD, a request comprising a first field identifying the SMD, wherein a second access point device is assigned to the SMD; and
communicating data to the first access point after (i) a first PMK-R1 is established on the first access point based on the request (ii) a first PTK is established on the first access point based on the request and (iii) a second PMK-R1 is established on the second access point based on the request identifying the SMD and based on the second access point device being assigned to the SMD.

22. The wireless device of claim 21, wherein the first access point and the second access point are assigned to an FT MD and wherein the request comprises a second field identifying the FT MD.

23. The wireless device of claim 22, wherein the first PMK-R1 matches the second PMK-R1 and wherein the first PMK-R1 is generated based on the second field.

24. The wireless device of claim 21, wherein the operation further comprises:
communicating, to the first access point device, a roaming request indicating a request to roam to the second access point device;
receiving, from the first access point device, a roaming response; and
generating a second PTK for communicating with the second access point device before roaming to the second access point device.

25. The wireless device of claim 24, wherein the roaming response comprises at least one of a nonce value or a public key of the second access point device and wherein the second PTK is generated based on at least one of the nonce value or the public key.

26. The wireless device of claim 24, wherein the operation further comprises generating a third PTK for communicating with a third access point device before roaming to the second access point device and wherein the third access point device is assigned to the SMD.

27. The wireless device of claim 24, wherein the roaming request comprises at least one of a nonce value or a public key for the wireless device and wherein the second PTK is generated based on at least one of the nonce value or the public key.

28. The wireless device of claim 24, wherein the roaming request comprises at least one of an identifier for the SMD or an identifier for an FT MD to which the first access point and the second access point are assigned.
